(19) United States
(12) Patent Application Publication
(10) Pub. No.: US 2024/0208816 A1
(43) Pub. Date: Jun. 27, 2024

(54) A SOLID FORMULATION FOR GENERATING CHLORINE DIOXIDE IN SITU AND A PROCESS FOR PREPARATION THEREOF

(71) Applicants: Nikunj SHAH, Pune, Maharashtra (IN); Keyur SHAH, Dubai (AE)

(72) Inventors: Nikunj SHAH, Pune, Maharashtra (IN); Keyur SHAH, Dubai (AE)

(21) Appl. No.: 18/566,801

(22) PCT Filed: Mar. 16, 2021
(86) PCT No.: PCT/IN2021/050266

§ 371 Date: Dec. 4, 2023

(30) Foreign Application Priority Data
Jan. 27, 2021 (IN) 202121003693

(51) Int. Cl. C01B 11/02

(52) U.S. Cl. CPC C01B 11/024

(57) ABSTRACT

The present disclosure provides a formulation for generating chlorine dioxide in situ when immersed in water having a pre-determined volume and a process for the preparation of the formulation. The formulation comprises at least one metal chlorite in an amount ranging from 15 to 25 weight %; at least one acid source in an amount ranging from 15 to 25 weight %; at least one free halogen source in an amount ranging from 10 to 15 weight %; at least one binder in an amount ranging from 12.5 to 17.5 weight %; at least one lubricant in an amount ranging from 0.1 to 1 weight %; and at least one desiccant in an amount ranging from 5 to 10 weight %, wherein the formulation is characterized by being stable at room temperature.

### FIELD

The present disclosure relates to a solid formulation for generating chlorine dioxide in situ and a process for preparation thereof.

### BACKGROUND

Chlorine dioxide is a yellowish green gas used for various applications in a liquid and gaseous form. Chlorine dioxide is an effective anti-microbial agent used for disinfection, fumigation and aesthetic treatment. It is a wide spectrum disinfectant used for multifarious applications such as drinking water treatment, cooling tower, food processing, indoor fumigation and the like.

There are various advantages of using chlorine dioxide over the more conventional chlorine, such as applicability in a wider pH range of 4-10 which makes it an excellent choice in cooling towers. Further, chlorine dioxide not only helps in improving the aesthetic properties of water such as color, odor and taste but also greatly impacts the water quality. Being a selective oxidizer and having much lower oxidation potential, chlorine dioxide causes much lower trihalomethanes and disinfection by-products.

However, chlorine dioxide suffers from several drawbacks that act as limiting factors in its implementation. Chlorine dioxide cannot be compressed or stored and has to be generated at site or point of use or point of demand. Chlorine dioxide gas is even prohibited from transportation in accordance with US Code of Federal Regulations (49 CFR 172.101). Chlorine dioxide is explosive in air above 10% and has a much lower Threshold Limit Value by OSHA of 0.1 ppm for exposure to workers or any human beings.

Methods of preparation of chlorine dioxide in situ are known in the art. Chlorine dioxide in a conventional form is prepared by mixing two or three liquid chemicals. The process is called as acidification of sodium chlorite where an acid is reacted with sodium chlorite to generate chlorine dioxide. The reaction is carried out in a closed container, or a reactor, and the resulting gas is mixed in water, such that the resulting aqueous solution is used as the treating chemical. Other process of generating chlorine dioxide are based on reaction with sodium chlorate and other chemicals, which also require a generator and liquid chemical dosing. Some other processes include producing chlorine dioxide by mixing two powders on site, in a bigger tank, with an average volume of 25 litre of water per 1 kg of powders. These processes are also associated with significant disadvantages such as the requirement of a minimum contact time of 3 to 4 hours post mixing of the powders; a constant change in the concentration of the resulting chlorine dioxide solution due to differential vapour pressure in the overhead space in the container; the difficulty in transporting the generated solution as none of the metals are compatible with chlorine dioxide, and finally a constant release of chlorine dioxide resulting in its gradual and consistent drop in concentration as chlorine dioxide gas is dissolved in water and forms an aqueous solution. Further, in the case of conventional two component powder systems, the maximum possible yield after converting chlorite to chlorine dioxide is 37%. Even further, due to the constant depletion in the stock solution concentration of chlorine dioxide solutions generated by liquids or powders, it is very difficult to pre-set the dose to a fixed value due to the constant variation in the stock solution concentration. Still further, the extremely high storage material incompatibility, makes these chlorine dioxide solutions, difficult to handle.

The inventors of the present disclosure provide a solid formulation for generating chlorine dioxide in situ and a process for preparation of the formulation that addresses the afore-mentioned drawbacks.

### Objects

It is an object of the present disclosure to provide a solid formulation for generating chlorine dioxide in situ.

It is another object of the present disclosure to provide a solid formulation for generating chlorine dioxide in situ when immersed in water.

It is yet another object of the present disclosure to provide a solid formulation for generating chlorine dioxide in situ which is chemically stable at room temperature and therefore is safe to handle.

It is still another object of the present disclosure to provide a solid formulation for generating chlorine dioxide in situ which is free from hazardous chemicals.

It is still another object of the present disclosure to provide a solid formulation for generating chlorine dioxide in situ which is available in multiple dosage forms.

It is yet another object of the present disclosure to provide a solid formulation for generating chlorine dioxide in situ, having a high yield.

It is still another object of the present disclosure to provide a solid formulation for generating chlorine dioxide in situ, having a high percentage of conversion.

It is yet another object of the present disclosure to provide a solid formulation for generating chlorine dioxide in situ, having a short dissolution time.

It is still another object of the present disclosure to provide a solid formulation for generating chlorine dioxide in situ, with a long shelf life.

It is yet another object of the present disclosure to provide a process for preparing the solid formulation for generating chlorine dioxide in situ.

### SUMMARY

The present disclosure relates to a formulation for generating chlorine dioxide in situ when immersed in water having a pre-determined volume and a process for the preparation of the formulation. The formulation comprises at least one metal chlorite in an amount ranging from 15 to 25 weight %; at least one acid source in an amount ranging from 15 to 25 weight %; at least one free halogen source in an amount ranging from 10 to 15 weight %; at least one binder in an amount ranging from 12.5 to 17.5 weight %; at least one lubricant in an amount ranging from 0.1 to 1 weight %; and at least one desiccant in an amount ranging from 5 to 10 weight %, wherein the formulation is characterized by being stable at room temperature.

### DESCRIPTION

In accordance with one aspect, the present disclosure provides a solid formulation for generating chlorine dioxide in situ when immersed or added or dissolved in water having a pre-determined volume. The formulation, in one embodiment, is a tablet. The formulation, in another embodiment, is a non-compacted blended powder. The formulation, upon coming in contact with water starts releasing chlorine dioxide in at least one form selected from the group consisting of aqueous solution and gaseous form. The formulation of the present disclosure, depending upon the amount of water it is dissolved in, can be used as a disinfectant for multiple applications. Typically, the pre-determined volume of water ranges from 0.1 liter to 10,000 liters per 20 g of formulation weight. In one embodiment, one 20 g tablet of the present formulation is used to disinfect 2000 to 5000 liters of drinking water. In another embodiment, one 20 g tablet of the present formulation is used for sanitizing and fumigating 4000 cubic feet of indoor air. In yet another embodiment, one 20 g tablet of the present formulation is used to disinfect 5000 liters of cooling tower recirculating water. In yet another embodiment, one 20 g tablet of the present formulation is used to disinfect 40000 liters of fish pond. In still another embodiment, one 20 g tablet of the present formulation is used to disinfect 6000 liters of water for poultry birds.

The formulation of the present disclosure comprises at least one ingredient selected from the group comprising at least one metal chlorite in an amount ranging from 15 to 25 weight %; at least one acid source in an amount ranging from 15 to 25 weight %; at least one free halogen source in an amount ranging from 10 to 15 weight %; at least one binder in an amount ranging from 12.5 to 17.5 weight %; at least one lubricant in an amount ranging from 0.1 to 1 weight %; and at least one desiccant in an amount ranging from 5 to 10 weight %. The formulation of the present disclosure is packed in a controlled environment and is packaged in a packaging material that creates a strong moisture barrier and prevents ingress of humidity. Consequently, the formulation of the present disclosure is characterized by being stable at room temperature.

The metal chlorite is one of the primary active ingredients and chlorine dioxide molecule is bounded in the metal chlorite. Metal chlorite on reacting with an acid, in the presence of moisture or water, releases chlorine dioxide. The metal chlorite of the formulation of the present disclosure is present in an amount ranging from 15 to 25 weight % and is at least one selected from the group consisting of alkali metal chlorites, alkaline earth metal chlorites and soluble metal chlorites. The metal chlorite of the present disclosure is at least one selected from the group consisting of sodium chlorite and potassium chlorite.

The acid source is one of the primary active ingredients and reacts with the metal chlorite in presence of water or moisture to release chlorine dioxide. Chlorine dioxide gas is generated by the acidification of metal chlorite. The acid source of the formulation of the present disclosure is present in an amount ranging from 15 to 25 weight % and is at least one selected from the group consisting of inorganic acid salts, organic acids and dicarboxylic acids and has pKa value ranging between 2.8 and 6. In accordance with the present disclosure, the acid source is at least one selected from the group consisting of sodium hydrogen sulfate, potassium hydrogen sulfate, sodium dihydrogen phosphate, potassium dihydrogen phosphate, boric acid, citric acid, tartaric acid, malic acid, maleic acid, oxalic acid and adipic acid. In one embodiment, the acid source is a dicarboxylic acid.

The free halogen source is included in the present formulation as it acts as a catalyst in accelerating the release of chlorine dioxide from the metal chlorite. The free halogen source speeds up the reaction time. The free halogen source of the formulation of the present disclosure is present in an amount ranging from 10 to 15 weight % and is at least one selected from the group consisting of dichloroisocyanuric acid, salts of dichloroisocyanuric acid, dihydrates of dichloroisocyanuric acid, trichlorocyanuric acid, hypochlorous acid, salts of hypochlorous acid, bromochlorodimethylhydantoin, dibromodimethylhydantoin, sodium bromide, potassium bromide, zinc bromide, sodium iodide and potassium iodide. In accordance with the present disclosure, salts of hypochlorous acid are selected from the group consisting of sodium hypochlorite, potassium hypochlorite and calcium hypochlorite.

A binder is included in the present formulation to bind the active ingredients as well as the other excipients in a predetermined solid form. The binder has adhesive properties, promotes cohesiveness and forms a bridge between the adjacent ingredients. The binder of the formulation of the present disclosure is present in an amount ranging from 12.5 to 17.5 weight % and is at least one selected from the group consisting of mannitol, lactose, starch 1500, sodium carboxymethyl cellulose, cross povidone, disaccharides, microcrystalline cellulose, polyvinyl pyrrolidone, polyethylene glycol and croscarmellose sodium.

Lubricants are added in the present disclosure in a very small value. The lubricant reduces the friction between the tablet and the die metal surface, which reduces the ejection force and ensures that tablet is cleanly ejected without cracking or breakage. The lubricant of the formulation of the present disclosure is present in an amount ranging from 0.1 to 1 weight % and is at least one selected from the group consisting of magnesium stearate, talc, lactose, sodium laurel sulphate and polyvinylpyrrolidone (PVPK 30).

Desiccants are included in the present formulation to control the moisture and humidity inside the package. Desiccants function on the basis of chemical adsorption, by adsorbing moisture from the blend and finished product. The desiccant of the formulation of the present disclosure is present in an amount ranging from 5 to 10 weight % and is at least one selected from the group consisting of sodium chloride, calcium chloride, magnesium chloride, potassium chloride, sodium sulfate, calcium sulfate and magnesium sulfate. The desiccant is used for providing a moisture barrier and extending the shelf life of the formulation.

The formulation of the present disclosure optionally comprises at least one effervescent agent selected from the group consisting of sodium bicarbonate, potassium bicarbonate, sodium per carbonate, crosspovidone, sodium crosscaramelose in an amount ranging from 5% to 20%. The effervescent agent is included in the formulation to achieve faster dissolution.

In accordance with another aspect, the present disclosure provides a process for preparation of the afore-mentioned solid formulation of the present disclosure. The process comprises blending at least one metal chlorite in an amount ranging from 15 to 25 weight %, at least one acid source in an amount ranging from 15 to 25 weight %, at least one free halogen source in an amount ranging from 10 to 15 weight %, at least one binder in an amount ranging from 12.5 to 17.5 weight %, at least one lubricant in an amount ranging from 0.1 to 1 weight % and at least one desiccant in an amount ranging from 5 to 10 weight % at a speed ranging from 15-20 rpm, at a temperature below 25° C. and humidity below 35% to form at least one blend; and feeding the blend to a compaction machine to form the solid formulation. The chemicals that can be used for each class of compounds in this process is the same as that provided herein above, detailing the formulation. It is a characteristic of the present process that it does not require oiling the machine. Conventional tableting machines use oil lubrication, called lube cups and the rotating machine parts are kept submerged in engine oil or being constantly supplied with oil. The machined used for making the present process includes ball bearings which precludes such heavy handed use of oil. Consequently, the present process is at an advantage as compared to the conventional processes from safety and food hygiene standards as halogen compounds have a risk of catching fire in the presence of oil and cross contamination of finished products is not permitted as the tablets are using for treating food products, drinking water.

After years of experimentation involving innumerable permutations and combinations of ingredients and reaction parameters and conditions, the inventor of the present disclosure has arrived at the afore-mentioned formulation. The specific choice and grade of ingredients, the amounts, ratios and percentages in which they are to be included, the temperature, pressure, humidity conditions in which they are to be stored and handled as described herein above have been finalized after years of research and development. As a consequence of the above-mentioned characterizing features, the formulation of the present disclosure and the process of generating chlorine dioxide, in general, does not have the drawbacks associated with the prior art such as the requirement of a generator for chlorine dioxide preparation, presence of huge quantities water on site, severely long contact times, unstable concentrations of resulting chlorine dioxide solutions and lower yield. Further since the present formulation generates chlorine dioxide in situ at the site of use—the formulation tablets are to be dropped in the water tank to be disinfected, the difficulty in transporting and handling chlorine dioxide does not arise, which saves a lot of capital and operational expenditure. Still further, as a result of the afore-mentioned characterizing features, the present formulation can be manufactured in any shape or size, is easy to use and handle, has a rapid action and high yield—all factors highly desirable to the end user. Even further, the present formulation does not have any insoluble matter, clay and the like that may restrict the product usage in various applications. Still further, the formulation is characterized by being free from hydrocarbons and nitrogen containing compounds which ensures its overall safety. It is significant to note that following the afore-mentioned characterizing features and strictly controlled storage and handling conditions, allows safe mixing and storing two highly oxidizing (and therefore inflammable) materials such as sodium chlorite and the acid source. Furthermore, a consequence of the above-mentioned characterizing features is that the formulation of the present disclosure demonstrates the following superlative technical advantages:
the chlorine dioxide generated in situ is in the range of 8 weight %-17.5 weight %
the percentage conversion of the metal chlorite ranges from 50%-95%
the dissolution time ranges from 3 minutes-5 minutes
the formulation has a very long shelf life ranging from 12-18 months
the pH of chlorine dioxide generated in situ ranges from 1.5 to 9
the pH of chlorine dioxide generated in situ ranges from 5.5 to 6.5
the shelf life of chlorine dioxide generated in situ ranges from 7-10 days.

In view of the above, the specific choice of ingredients and their specific percentages provides a synergistic effect as compared to properties of each ingredient separately.

Even further, the above-mentioned characterizing features ensure that the formulation can be prepared by a 3 steps process comprising weighing, blending and tableting—a sharp contrast to the conventional tableting process that includes numerous steps such as wet granulation, drying, dry granulation, roll compaction, milling and sifting. It further ensures that the formulation does not require any pre-treatment such as heating, drying, granulation or roll compaction and is ready for direct compression, followed by packing. Consequently, the above-mentioned characterizing features ensure that the present formulation can be prepared in 3 steps instead of 9.

Some non-limiting examples of the present formulation and its process of preparation are provided herein after.

### Process of Preparation of the Formulation of the Present Disclosure:

All the ingredients were measured with precision and mixed well in a blender at a speed ranging from 15-20 rpm, at a temperature below 25° C. and humidity below 35%. The homogenized blend was fed to a tableting machine or extrusion machine or any other machine used for the purpose of compaction and converted into desired weight, size and shape as described below. The resulting tablets were round with flat beveled edges and with diameters and weights varying from 0.5 g to 30 g and 8 mm to 30 mm.

### Example-1

Tablets were made with 30 mm dies and punches and hardness was kept between 9 to 10. The tablet was dropped in 1 litre flask and dissolution was observed. 5 min after adding the tablet in water the solution was tested for the % yield and Chlorine dioxide percentage.

### Example-2

Tablets were made with 30 mm dies and punches and hardness was kept between 9 to 10. The tablet was dropped in 1 litre flask and dissolution was observed. 5 min after adding the tablet in water the solution was tested for the % yield and Chlorine dioxide percentage.

### Example-3

Tablets were made with 25 mm dies and punches and hardness was kept between 9 to 10. The tablet was dropped in 1 litre flask and dissolution was observed. 5 min after adding the tablet in water the solution was tested for the % yield and Chlorine dioxide percentage.

### Example-4

Tablets were made with 25 mm dies and punches and hardness was kept between 3-5 The tablet was dropped in 1 litre flask and dissolution was observed. 5 min after adding the tablet in water the solution was tested for the % yield and Chlorine dioxide percentage. The solution was hazy with insoluble tartaric acid.

### Example-5

Tablets were made with 25 mm dies and punches and hardness was kept between 3-5 The tablet was dropped in 1 litre flask and dissolution was observed. 63 min after adding the tablet in water the solution was tested for the % yield and Chlorine dioxide percentage. The solution was hazy with insoluble precipitation at the bottom.

### Example-6

Tablets were made with 30 mm dies and punches and hardness was kept between 7-8 The tablet was dropped in 1 litre flask and dissolution was observed. 27 min after adding the tablet in water the solution was tested for the % yield and Chlorine dioxide percentage. The solution was hazy with insoluble precipitation at the bottom.

### Example-7

Tablets were made with 30 mm dies and punches and hardness was kept between 7-8 The tablet was dropped in 1 litre flask and dissolution was observed. 6 min after adding the tablet in water the solution was tested for the % yield and Chlorine dioxide percentage. Clear solution without any suspended impurities.

### Example-8

Tablets were made with 30 mm dies and punches and hardness was kept between 7-8 The tablet was dropped in 1 litre flask and dissolution was observed. 6 min after adding the tablet in water the solution was tested for the % yield and Chlorine dioxide percentage. The solution was hazy with insoluble precipitation at the bottom.

### Example-9

Tablets were made with 12 mm dies and punches and hardness was kept between 9 to 10. The tablet was dropped in 1 litre flask and dissolution was observed. 5 min after adding the tablet in water the solution was tested for the % yield and Chlorine dioxide percentage. The solution was manually agitated or stirred or shake, to homogenise the ClO2 across the entire volume of water.

### Example-10

Tablets were made with 20 mm dies and punches and hardness was kept between 9 to 10. The tablet was dropped in 4 litre flask and dissolution was observed. 5 min after adding the tablet in water the solution was tested for the % yield and Chlorine dioxide percentage.

### Example-11

Tablets were made with 25 mm dies and punches and hardness was kept between 9 to 10. The tablet was dropped in 5 litre flask and dissolution was observed. 5 min after adding the tablet in water the solution was tested for the % yield and Chlorine dioxide percentage.

### Example-12

Tablets were made with 25 mm dies and punches and hardness was kept between 9 to 10. The tablet was dropped in 10 litre flask and dissolution was observed. 5 min after adding the tablet in water the solution was tested for the % yield and Chlorine dioxide percentage.

### Example-13

Tablets were made with 30 mm dies and punches and hardness was kept between 9 to 10. The tablet was dropped in 20 litre flask and dissolution was observed. 5 min after adding the tablet in water the solution was tested for the % yield and Chlorine dioxide percentage.

### Performance Testing of the Example Formulations:

The formulations were individually added in containers filled with known amount of tap water and their performance was checked for the following criteria:
Weight
Hardness
Dissolution time
Chlorine dioxide concentration (Checked as per DIN 12671:2015, BSEN 12671:2016 method, with Iodometric titration and Water I.D, Water testing Equipment, Primelab—Multitest spectrophotometer.
Percentage conversion from chlorite to chlorine dioxide
pH of the solution (with pH electrode)
% yield of chlorine dioxide
Percentage of insoluble matter
Shelf life of formulation and chlorine dioxide solution test and results

### Results:

Sodium chlorite used was approximately of 80% purity. Hence while calculating percentage yield, conversion of the same was considered.

% Yield=100×moles of chlorine dioxide produced/moles of sodium chlorite in tablet.

Chlorine dioxide ppm was checked in spectrophotometer, by using glycine, to avoid interference coming due to free chlorine which will always come in an iodometric titration. Hence the results from iodometric substances are the addition of all the oxidative substances present in the sample which is tested. Hence both the results are mentioned for purpose of reference but the results by spectrophotometer are considered as final value. The results of all the examples are provided herein below:

TABLE 1

| Ingredient | | | | |
|---|---|---|---|---|
| class | Example 1 | Example 2 | Example 3 | Example 4 |
| Metal | Sodium | Sodium chlorite | Sodium | Sodium |
| chlorite | chlorite 22% | 17.5% | chlorite 20% | chlorite 20% |
| Free | Dichloroisocynurate | Dichloroisocynurate | Dichloroisocynurate | Dichloroisocynurate |
| halogen | 12.5% | 12.5% | 12.5% | 12.5% |
| source | | | | |
| Acid source | Malic acid | Malic acid 25% | Adipic acid | Adipic acid |
| | 16.5% | | 20% | 20% |
| | | | | Tartaric acid- |
| | | | | 2.5% |
| Binder | PVPK 30-7% | Sodium CMC- | PVPK 30-7% | Sodium CMC- |
| | | 8% | | 8% |
| Lubricant | SODIUM | Magnesium | SODIUM | Magnesium |
| | LAURL | Stearate - 1% | LAURL | Stearate-1% |
| | SULPHATE- | | SULPHATE | |
| | 0.75% | | (SLS)-0.75% | |
| Desiccant | SODIUM | Magnesium | SODIUM | SODIUM |
| | SULPHATE- | chloride-20% | SULPHATE- | SULPHATE- |
| | 22% | | 22% | 23% |
| Effervescent | Sodium | Potassium | Sodium | Cross povidone |
| Agent | Bicarbonate- | bicarbonate- | Bicarbonate- | |
| | 20% | 22% | 20% | |
| Tablet | 20 g | 20 g | 10 g | 10 g |
| weight | | | | |
| Volume of | 1 lit | 1 lit | 1 lit | 1 lit |
| water | | | | |
| Dissolution | 8 min | 8 min | 4-5 min | 7-8 min |
| time | | | | |
| Chlorine | 1920 ppm | 2050 ppm | 1020 ppm | 1130 ppm |
| dioxide | | | | |
| Chlorine | 9.6% | 10.5% | 10.2% | 11.3% |
| dioxide | | | | |
| generated | | | | |
| pH of stock | 6.4 | 4.4 | 5.5 | 6 |
| solution | | | | |
| Solution | Clear Solution- | Slightly Hazy- | Clear | Hazy liquid- 1 |
| Appearance | 3 days | 4 days | Solution-2 | day |
| and Shelf | | | days | |
| Life | | | | |
| Total | Less than 10 | Less than 100 | Less than 10 | More than 1000 |
| suspended | ppm | ppm | ppm | ppm |
| solid | | | | |
| % yield | 54.5 | 75 | 63 | 70.62 |
| Comment | Tablets Bulged | Tablets bulged | Tablets stable | Tablets lost |
| | inside pouch | inside pouch. | for 1 year | hardness after 5 |
| | | | | months |

TABLE 2

| Ingredient | | | | |
|---|---|---|---|---|
| class | Example 5 | Example 6 | Example 7 | Example 8 |
| Metal | Sodium | Sodium chlorite | Sodium | Sodium |
| chlorite | chlorite 22.5% | 20% | chlorite 20% | chlorite 22.5% |
| Free | Calcium | Sodium | Sodium | Sodium |
| halogen | hypochlorite | dichloroisocynurate | dichloroisocynurate | dichloroisocynurate |
| source | 12.5% | 10% | 10% | 11% |
| Acid source | Adipic acid | Adipic acid | Sodium | Malic acid |
| | 22.5% | 15% | bisulphate | 22.5% |
| | | Citric acid 5% | 20% | Tartaric acid- |
| | | | | 0.5% |
| Binder | PVPK 30-7% | Sodium CMC- | PVPK 30-8% | Sodium CMC- |
| | | 5% | | 5% |
| Lubricant | Talc-0.5% | Talc-0.5% | SLS-0.75% | Talc-0.5% |
| Desiccant | Calcium | Magnesium | Calcium | Calcium sulfate |
| | sulfate 7% | chloride-18% | chloride-15% | 7% |
| Effervescent | Sodium | Potassium | Sodium | Sodium |
| Agent | bicarbonate- | bicarbonate- | Bicarbonate- | percarbonate |
| | 3% | 3% | 15% | 5% |
| | | crosspovidone- | | |
| | | 2% | | |
| Tablet | 10 g | 20 g | 20 g | 20 g |
| weight | | | | |
| Volume of | 1 lit | 1 lit | 1 lit | 1 lit |
| water | | | | |
| Dissolution | 63 min | 27 min | 6 min | 5 min |
| time | | | | |
| Chlorine | 950 ppm | 1760 ppm | 1960 ppm | 1730 ppm |
| dioxide | | | | |
| Percentage | 9.5% | 8.8% | 9.8% | 8.35% |
| Chlorine | | | | |
| dioxide | | | | |
| generated | | | | |
| pH of stock | 7 | 5.5 | 4 | 4.5 |
| solution | | | | |
| Solution | Hazy and | Slightly Hazy- | Clear | Hazy liquid-1 |
| Appearance | turbid Solution- | 4 days | Solution-2 | day |
| and Shelf | 1 day | | days | |
| Life | | | | |
| Total | More than | Less than 100 | Less than 10 | More than 1000 |
| suspended | 1000 pm | ppm | ppm | ppm |
| solid | | | | |
| % yield | | 55% | 63 | 70.62 |
| Comment | Not considered | Powder sticked | Tablets stable | Tablets bulged |
| | as tablet | to the dies and | for 1 year. | in 7 days. |
| | ignited during | punches. | | |
| | production. | | | |

TABLE 3

| Ingredient | | | | |
|---|---|---|---|---|
| class | Example 9 | Example 10 | Example 11 | Example 12 |
| Metal | Sodium | Sodium chlorite | Sodium | Sodium |
| chlorite | chlorite 22.5% | 22.5% | chlorite 22.5% | chlorite 22.5% |
| Free | Dichloroisocynurate | Dichloroisocynurate | Dichloroisocynurate | Dichloroisocynurate |
| halogen | 12.5% | 12.5% | 12.5% | 12.5% |
| source | | | | |
| Acid source | Adipic acid | Adipic acid | Adipic acid | Adipic acid |
| | 22.5% | 22.5% | 22.5% | 22.5% |
| Binder | Sodium | Croscarmellose | Lactose-7% | PVPK-30-7% |
| | CMC7% | sodium-5% | | Lactose -7% |
| Lubricant | SLS -0.5% | Magnesium | SLS-0.5% | Lactose-1% |
| | | Stearate-1% | | |
| Desiccant | Sodium | Magnesium | Calcium | Sodium |
| | sulphate-15 % | chloride-15% | chloride- | sulphate- |
| | | | 15% | 7.5% |
| Effervescent | Sodium | Sodium | Potassium | Sodium |
| Agent | Bicarbonate - | Bicarbonate- | bicarbonate- | bicarbonate- |
| | 15% and Cross | 15% | 15% | 20% |
| | Povidone-5 % | | | |
| Tablet | 1 g | 4 g | 5 g | 10 g |
| weight | | | | |
| Volume of | 1 lit | 4 lit | 5 lit | 10 lit |
| water | | | | |
| Dissolution | 3 min | 3.5 min | 3.2 min | 3 min |
| time | | | | |
| Chlorine | 145 ppm | 154 ppm | 163 ppm | 169 ppm |
| dioxide | | | | |
| Percentage | 14.5% | 15.4% | 16.3% | 16.9% |
| Chlorine | | | | |
| dioxide | | | | |
| generated | | | | |
| pH of stock | 6 | 5.9 | 6.5 | 6.8 |
| solution | | | | |
| % yield | 81% | 85% | 88% | 93% |
| Solution | Clear solution- | Slightly Hazy- | Clear | Clear solution |
| Appearance | 5 day | 4 days | Solution-7 | for 9-10 days. |
| and Shelf | | | days | |
| Life | | | | |
| Total | Less than 10 | Less than 100 | Less than 10 | More than 1000 |
| suspended | ppm | ppm | ppm | ppm |
| solid | | | | |
| Comment | Tablets stable | Tablets stable | Tablets stable | Tablets stable |
| | for 12 months. | for 12 months. | for 12-14 | for 18 months |
| | | | months | |

TABLE 4

| Ingredient | |
|---|---|
| class | Example 13 |
| Metal chlorite | Sodium |
| | chlorite 22.5% |
| Free halogen | Dichloroisocynurate |
| source | 12.5% |
| Acid source | Adipic acid |
| | 22.5% |
| Binder | PVPK 30-7% |
| | and Lactose - |
| | 7% |
| Lubricant | Lactose-1% |
| Desiccant | Sodium |
| | sulphate- |
| | 7.5% |
| Effervescent | Sodium |
| Agent | bicarbonate- |
| | 20% |
| Tablet weight | 20 g |
| Volume of | 20 lit |
| water | |
| Dissolution | 3 min |
| time | |
| Chlorine | 169 ppm |
| dioxide ppm | |
| Percentage | 16.9% |
| Chlorine | |
| dioxide | |
| generated | |
| pH of stock | 6.8 |
| solution | |
| % yield | 93% |
| Solution | 10 days. |
| Appearance | |
| and Shelf Life | |
| Total | Less than 10 |
| suspended | ppm |
| solid | |
| Comment | Tablets stable |
| | for 18 months. |

As observed, examples 12 and 13 are the best representative examples of the present formulation. In one exemplary embodiment, the formulation of the present disclosure comprises 22.5% sodium chlorite as metal chlorite, 22.5% adipic acid as acid source, 12.5% sodium dichloroisocyanuriate as free halogen source, 7% lactose and 7% polyvinylpyrrolidone as binder, 1% lactose as lubricant, 7.5% sodium sulfate as desiccant and 20% sodium bicarbonate as effervescent agent. Further, the percentage of chlorine dioxide generated should be minimum 8%, 12% preferable and 16% as a most favorable condition; the percentage conversion of the metal chlorite should be minimum—30%, 50% as preferable and 75% as most favorable result; the dissolution time should be minimum 5 min, 4 min preferable and 3 min as most favorable result and pH of the solution should be between 5.5 to 6.5.

The embodiments described herein above are non-limiting. The foregoing descriptive matter is to be interpreted merely as an illustration of the concept of the present disclosure and it is in no way to be construed as a limitation. Description of terminologies, concepts and processes known to persons acquainted with technology has been avoided for the sake of brevity.

### Technical Advantages and Economic Significance

The technical advantages and economic significance of the formulation of the present disclosure are presented herein after:
the chlorine dioxide generated in situ is in the range of 8 weight %-17.5 weight %
the percentage conversion of the metal chlorite ranges from 50%-95%
the dissolution time ranges from 3 minutes-5 minutes
the formulation has a very long shelf life ranging from 12-18 months
the pH of chlorine dioxide generated in situ ranges from 1.5 to 9
the pH of chlorine dioxide generated in situ ranges from 5.5 to 6.5
the shelf life of chlorine dioxide generated in situ ranges from 7-10 days.

1. A solid formulation for generating chlorine dioxide in situ when immersed in water having a pre-determined volume; said formulation comprising:
a. at least one metal chlorite in an amount ranging from 15 to 25 weight %;
b. at least one acid source in an amount ranging from 15 to 25 weight %;
c. at least one free halogen source in an amount ranging from 10 to 15 weight %;
d. at least one binder in an amount ranging from 12.5 to 17.5 weight %;
e. at least one lubricant in an amount ranging from 0.1 to 1 weight %; and
f. at least one desiccant in an amount ranging from 5 to 10 weight %;
wherein said formulation being characterized by being is stable at room temperature; free from hydrocarbons and nitrogen containing compounds, generates chlorine dioxide in situ in the range of 8 weight %-17.5 weight %; has percentage conversion of the metal chlorite ranging from 50%-95%; has dissolution time ranging from 3 minutes-5 minutes; has shelf life ranging from 12-18 months; and wherein a pH of chlorine dioxide generated in situ ranges from 1.5 to 9 and the shelf life of chlorine dioxide generated in situ ranges from 7-10 days; and
wherein said pre-determined volume of water ranges from 0.1 liter to 10,000 liters per 20 g of formulation weight.

2. (canceled)

3. The formulation as claimed in claim 1, wherein said chlorine dioxide generated in situ is in at least one form selected from the group consisting of aqueous solution and gaseous form.

4. (canceled)

5. The formulation as claimed in claim 1, wherein said metal chlorite is at least one member selected from the group consisting of alkali metal chlorites, alkaline earth metal chlorites and soluble metal chlorites.

6. The formulation as claimed in claim 1, wherein said metal chlorite is sodium chlorite.

7. The formulation as claimed in claim 1, wherein said acid source is at least one member selected from the group consisting of inorganic acid salts, organic acids and dicarboxylic acids and has pKa value ranging between 2.8 and 6.

8. The formulation as claimed in claim 1, wherein said acid source is at least one member selected from the group consisting of sodium hydrogen sulfate, potassium hydrogen sulfate, boric acid, citric acid, tartaric acid, malic acid, maleic acid, oxalic acid and adipic acid.

9. The formulation as claimed in claim 1, wherein said free halogen source is at least one member selected from the group consisting of dichloroisocyanuric acid, salts of dichloroisocyanuric acid, dehydrates of dichloroisocyanuric acid, trichlorocyanuric acid, hypochlorous acid, salts of hypochlorous acid, bromochlorodimethylhydantoin, dibromodimethylhydantoin, sodium bromide, potassium bromide, zinc bromide, sodium iodide and potassium iodide.

10. The formulation as claimed in claim 1, wherein said binder is at least one member selected from the group consisting of mannitol, lactose, starch 1500, sodium carboxymethyl cellulose, cross povidone, disaccharides, microcrystalline cellulose, polyvinyl pyrrolidone and croscarmellose sodium.

11. The formulation as claimed in claim 1, wherein said lubricant is selected from the group consisting of magnesium stearate, talc, lactose, sodium laurel sulphate and polyvinylpyrrolidone (PVPK 30).

12. The formulation as claimed in claim 1, wherein said desiccant is selected from the group consisting of sodium chloride, calcium chloride, magnesium chloride, potassium chloride, sodium sulfate, calcium sulfate and magnesium sulfate.

13. The formulation as claimed in claim 1, optionally comprising at least one effervescent agent in an amount ranging from 5% to 20% selected from the group consisting of sodium bicarbonate, potassium bicarbonate, sodium per carbonate, cross povidone and sodium croscarmellose.

14. The formulation as claimed in claim 1, having a dosage form selected from the group consisting of a tablet and a non-compacted blended powder.

15-21. (canceled)

22. A process for preparing a solid formulation for generating chlorine dioxide in situ when immersed in water having a pre-determined volume; said process comprising:
a. blending at least one metal chlorite, selected from the group consisting of alkali metal chlorites, alkaline earth metal chlorites and soluble metal chlorites, in an amount ranging from 15 to 25 weight %, at least one acid source, selected from the group consisting of inorganic acid salts, organic acids and dicarboxylic acids in an amount ranging from 15 to 25 weight %, at least one free halogen source, selected from the group consisting of dichloroisocyanuric acid, salts of dichloroisocyanuric acid, dehydrates of dichloroisocyanuric acid, trichlorocyanuric acid, hypochlorous acid, salts of hypochlorous acid, bromochlorodimethylhydantoin, dibromodimethylbydantoin, sodium bromide, potassium bromide, zinc bromide, sodium iodide and potassium iodide, in an amount ranging from 10 to 15 weight %, at least one binder, selected from the group consisting of mannitol, lactose, starch 1500, sodium carboxymethyl cellulose, cross povidone, disaccharides, microcrystalline cellulose, polyvinyl pyrrolidone, polyethylene glycol and croscarmellose sodium, in an amount ranging from 12.5 to 17.5 weight %, at least one lubricant, selected from magnesium stearate, talc, sodium laurel sulphate lactose and polyvinylpyrrolidone (PVPK 30), in an amount ranging from 0.1 to 1 weight % and at least one desiccant, selected from the group consisting of sodium chloride, calcium chloride, magnesium chloride, potassium chloride, sodium sulfate, calcium sulfate and magnesium sulfate, in an amount ranging from 5 to 10 weight % at a speed ranging from 15-20 rpm, and optionally at least one effervescent agent in an amount ranging from 5% to 20% selected from the group consisting of sodium bicarbonate, potassium bicarbonate, sodium per carbonate, crosspovidone and sodium crosscaramelose; at a temperature below 25° C. and humidity below 35% to form at least one blend; and
b. feeding said admixture to a compaction machine to form at least one solid formulation, said process being characterized by not requiring any pre-treatment selected from the group consisting of heating, drying, granulation and roll compaction and is ready for direct compression, followed by packing.

23. (canceled)

24. The process as claimed in claim 22, wherein said metal chlorite is sodium chlorite.

25. (canceled)

26. The process as claimed in claim 22, wherein said acid source is at least one member selected from the group consisting of sodium hydrogen sulfate, potassium hydrogen sulfate, sodium dihydrogen phosphate, potassium dihydrogen phosphate, boric acid, citric acid, tartaric acid, malic acid, maleic acid, oxalic acid and adipic acid and has pKa value ranging between 2.8 and 6.

27-31. (canceled)
